(19) United States
(12) Patent Application Publication
(10) Pub. No.: US 2019/0201921 A1
(43) Pub. Date: Jul. 4, 2019

(54) MACHINE AND METHOD FOR INSTALLING LOOSE-FILL FIREWALL INSULATION

(71) Applicant: Michael Brown, Winter Garden, FL (US)

(72) Inventor: Michael Brown, Winter Garden, FL (US)

(21) Appl. No.: 15/987,656

(22) Filed: May 23, 2018

Related U.S. Application Data
(60) Provisional application No. 62/613,269, filed on Jan. 3, 2018.

(51) Int. Cl. B05B 7/14; E04B 1/76

(52) U.S. Cl. CPC B05B 7/1463; E04B 2001/742; E04B 1/7604

(57) ABSTRACT

A loose-fill granular insulation blowing machine includes a main body having an internal frame and a hopper chamber that is positioned along the top end of the main body. A grate is positioned beneath the hopper and a dispensing chamber is located along the bottom end of the main body. A funnel section is interposed between the grate and the dispensing chamber, and a valve is positioned along the bottom of the funnel. An agitator having a motorized central shaft and a plurality of paddles is positioned within the dispenser chamber. A blower having an inlet is positioned along one side of the dispenser chamber and an outlet is positioned along the opposite side of the dispenser chamber. A plurality of air diffusers are positioned within the dispenser chamber. Each of the diffusers are in communication with an air coupler that is removably secured to an air compressor.

### CROSS-REFERENCE TO RELATED APPLICATIONS

This application claims the benefit of U.S. Application Ser. No. 62/613,269 filed on Jan. 3, 2018, the contents of which are incorporated herein by reference.

### TECHNICAL FIELD

The present invention relates generally to construction equipment, and more particularly to a machine and method for installing loose-fill firewall insulation.

### BACKGROUND

The statements in this section merely provide background information related to the present disclosure and may not constitute prior art.

In the building construction industry, it is a requirement to create a 4-hour firewall at key points throughout the building's structure. When working with masonry walls, it is necessary to utilize a loose-fill insulation material that can be positioned within the wall cells. To this end, the most common types of loose fill insulation for creating a 4-hour firewall are lightweight granular materials such as Perlite, Vermiculite and Zonalite, for example. Such materials are versatile and sustainable minerals that are mined and processed with a negligible impact on the environment.

Owing to the physical makeup of this class of loose-fill insulation, current methods for creating 4-hour firewalls requires a worker to manually pour bags of the loose granular material into the open cells (e.g., the hollow sections of masonry blocks), located on the top of a wall until all of the cells are filled. However, in order to access the open cells, the top of the wall must remain accessible, thus preventing workers from fully sealing the wall and adding the finishing touches such as the bond beam, for example.

Such a requirement adds additional burdens to project managers who must schedule each trade in a manner that does not interfere with another. Additionally, the process of pouring bags of loose granular insulation down the top of a masonry wall causes a significant amount of waste, as much of the material is spilled and/or carried away by wind or other weather conditions. Further, because the material relies on gravity to carry it downward, it is not packed tightly within each wall cell. As a result, if/when an opening is drilled into the wall, as may be required for electrical or utility access, it is not uncommon for much of the granular insulation within a cell to pour out of the wall via the opening.

Accordingly, it would be beneficial to provide a machine and method for installing granular style loose-fill firewall insulation into a completed masonry wall that does not suffer from the drawbacks noted above.

### SUMMARY OF THE INVENTION

The present invention is directed to a loose-fill granular insulation blowing machine. One embodiment of the present invention can include a main body having an internal frame. A hopper chamber can be positioned along the top end of the main body and can function to receive bags of loose-fill insulation material. A grate is positioned beneath the hopper and can function to prevent portions of the bag from passing through. A dispensing chamber is located along the bottom end of the main body and is connected to the grate via a funnel section. The dispensing chamber can include an agitator for disrupting the granular material, and a blower unit can create an airflow for dispensing the granular material through an outlet.

In one embodiment, a valve can be positioned between the funnel and dispenser chamber. The valve can function to allow the material to move from the funnel into the dispenser chamber and to prevent the airflow and material from passing from the dispenser chamber into the funnel.

In one embodiment, a plurality of air diffusers can be positioned within the dispenser chamber. The diffusers can be in communication with an air coupler that can receive pressurized air from an air compressor.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a loose-fill granular insulation blowing machine that is useful for understanding the inventive concepts disclosed herein.

FIG. 2 is a partially cutaway side view of the loose-fill granular insulation blowing machine in accordance with one embodiment of the invention.

FIG. 3 is a partially cutaway front view of the loose-fill granular insulation blowing machine in accordance with one embodiment of the invention.

FIG. 4 is a process flowchart for installing loose-fill granular insulation within a building wall utilizing the loose-fill granular insulation blowing machine in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described throughout this document with regard to loose-fill granular insulation for creating a 4-hour firewall within a masonry structure, this is for illustrative purposes only. To this end, the below described machine, system and/or methodology can be utilized for dispensing any number of different materials and/or can be used with any type of building wall structures.

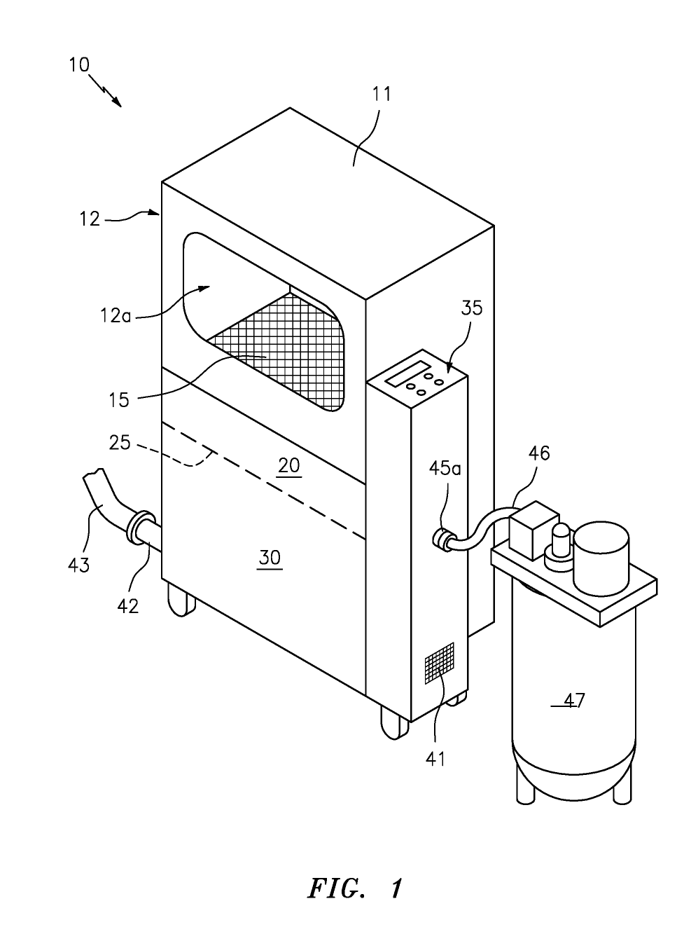

In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-3 illustrate one embodiment of a loose-fill granular insulation machine 10 that is useful for understanding the inventive concepts. As shown, the machine 10 can include a main body 11 having a hopper chamber 12, a grate 15, a funnel chamber 20, and a dispenser chamber 30.

The main body 11 can include a frame and housing panels of various shapes and sizes for positioning each of the device components. As described herein, the main body 11 may be formed from materials that are, for example, relatively strong and stiff for their weight. Several nonlimiting examples include, but are not limited to, various metals or metal alloys (e.g., aluminum, steel, titanium, or alloys thereof), plastic/polymers (e.g., high-density polyethylene (HDPE) or polyethylene terephthalate (PET)), and/or various composite materials (e.g., carbon fibers in a polymer matrix, etc.).

The hopper chamber 12 can be positioned along the upper portion of the main body and can function to receive the granular loose-fill insulation material. Although illustrated as including an opening 12a along the front wall, the opening can be positioned along any side of the main body, including the top end. Moreover, an optional shelf (not illustrated) can be positioned along the outside of the main body adjacent to the opening to aid a user in positioning a bag of insulation material before pouring the granular contents into the hopper.

As shown, a grate/lattice 15 can be positioned along the bottom of the hopper chamber 12. The primary function of the grate is to prevent foreign objects and to ensure that no portion of the (typically paper) bag containing the granular fire-resistant insulation material passes through the system, as such materials are flammable and can reduce the effectiveness of the fire insulation.

A secondary function of the grate is to break apart any large clumps of insulation material that have accumulated within the bag. The grate will preferably be constructed from metal, and the grate openings can preferably include a dimension/diameter that is less than 1 inch. Of course, other materials and dimensions are also contemplated.

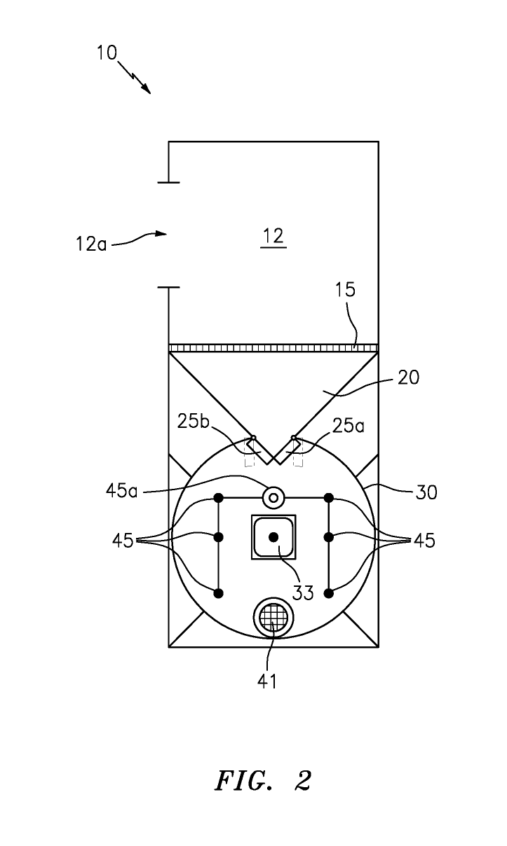

As shown best in FIG. 2, the main body can include a funnel chamber 20 that is positioned between the bottom end of the grate 15 and the top end of the agitation chamber 30. As shown, the funnel chamber can gradually narrow to form an elongated slit along the bottom end where a valve 25 is located. The valve 25 can include, comprise or consist of any number of one-way valves that are capable of allowing the granular insulation material exiting the grate 15 to be deposited into the chamber 30, while preventing material located within the agitation chamber from passing upward into the funnel chamber.

In the preferred embodiment, the valve 25 can include a pair of elongated angular flaps 25a and 25b that can be hingedly secured to the main body along their distal ends to individually transition between an open and closed orientation. In the closed orientation, the valves can form a generally V-shape, wherein in the open position the valves can be positioned parallel with their bottom ends not touching. As described herein, the valve can be constructed from any number of different materials such as various metals, for example, and can further include any number of gaskets for preventing airflow associated with the below described blower unit and/or compressor from escaping upward into the hopper.

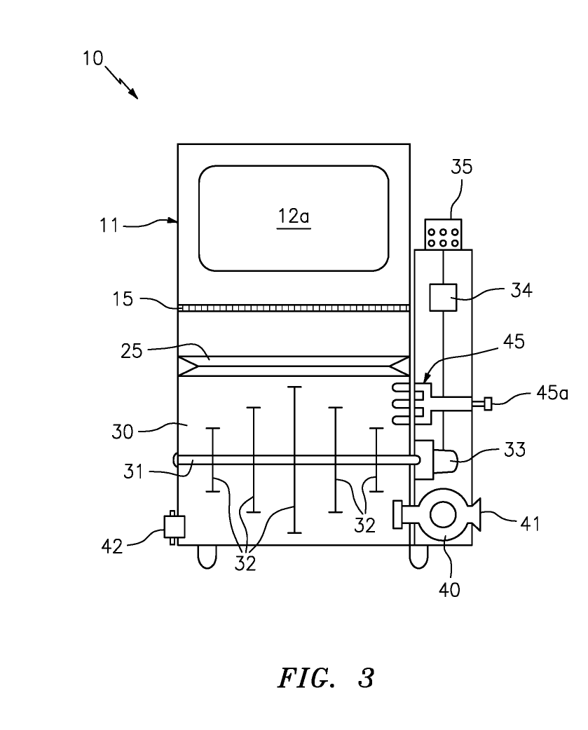

The dispenser chamber 30 can include a semi-cylindrical chamber that is in communication with the valve 25 along the top end. As shown in FIG. 3, the chamber can include an agitator that includes a central hub 31 having a plurality of paddles 32 arranged radially. A motor 33 can be connected to the central hub and can be controlled by a system control panel 34 (e.g., solid state or analog) having one or more actuators 35 such as buttons or switches, for example. The control panel can selectively operate the motor to rotate the paddles at any number of user-defined speeds, so as to thoroughly agitate the granular material in order to allow it to be captured by the airstream generated by the blower and/or compressor.

As described herein, each of the paddles can be any number of different shapes and sizes, and can be constructed from any number of different materials such as plastic, metal, or rubber, for example. Each of the paddles can include bristles or other such materials and can be positioned above or below the valve.

An electric blower 40 can be positioned along the bottom end of the main body. The blower draws air from the inlet 41 and through the chamber 30 and then through the outlet 42 to distribute granular insulation materials. Attached to the outlet 42 is a distribution hose 43, for directing the flow of granular insulation toward an aperture in a building wall. As described herein, the electric blower can include, comprise or consist of any number of commercially available blower/fan units capable of performing the functionality described herein. In the preferred embodiment, the blower will be capable of generating airflow of between 90 and 120 CFM; however other flow rates are also contemplated.

In one embodiment, the machine 10 can also include a plurality of air diffusers 45 which can be arranged at any number of different locations along the chamber 30. Each of the diffusers can be connected to an air inlet coupler 45a, such as a quick connect hose fitting for mating with an air hose 46 of an air compressor 47. Each of the air diffusers can function to generate additional streams of airflow through the chamber 30 to further increase the total CFM at the outlet 42. In the preferred embodiment, the compressor 47 and diffusers 45 can generate between 20 and 50 CFM; however other flow rates are also contemplated. Such flow rates having been found to be ideal for use in depositing the granular insulation material Pearlite into building wall apertures located between 10 and 20 feet from the ground.

Although illustrated with regard to an externally located and removably connected air compressor, other embodiments are also contemplated. To this end, in one embodiment the air compressor can be included as an integral component of the machine and can be controlled directly by the control panel and actuator(s).

As described herein, one or more elements of the machine 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

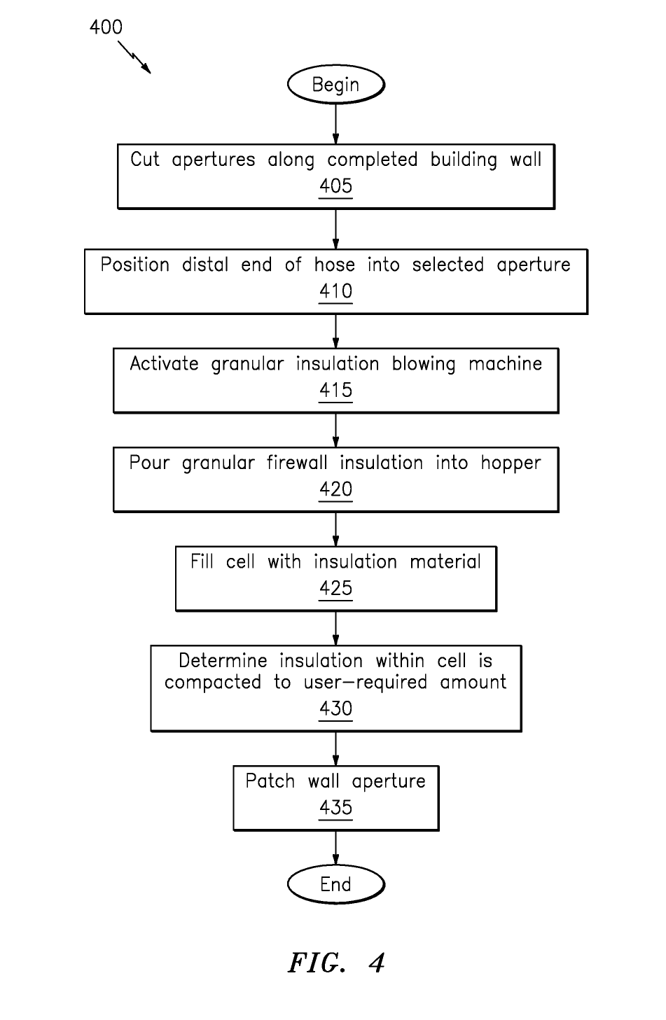

FIG. 4 illustrates one embodiment of a method of installing granular loose-fill firewall insulation using the machine 10.

The method can begin at step 405 wherein the user can cut a plurality of apertures into a wall. In the contemplated example, the wall will be a completed masonry wall that already has the bond beams, electrical and/or plumbing installed. Of course, the machine and associated methodology are not limited to such a use, as the machine can be utilized with any type of wall that is in any phase of construction. In either instance, the apertures can be positioned along the top end of the wall so as to engage the open cells.

Next, the method can proceed to step 410, wherein the user can position the distal end of the distribution hose 43 into one of the apertures. In various embodiments, the distal end of the hose can include a formed fitting having a shape and size that is complementary to the shape and size of the aperture so as to prevent excess insulation material from escaping during the dispensing operation.

When the hose is secured to the aperture, a user can activate the machine 10 at step 415, which will cause the motor 33 to spin the paddles 32. Likewise, the blower 40 and/or air compressor 47 can be activated to create a specific user-defined airflow based on the weight/density of the particular type of loose-fill material being utilized and/or the height of the apertures in the wall.

Once the machine has been activated, the method can proceed to step 420 wherein another user can pour the loose-fill granular insulation into the hopper 12. At this time, the material will flow through the grate 15, funnel 20 and valve 25 where it will be engaged by the paddles 32 and carried by the airstream through the hose 43 and into the wall at step 425.

This process can continue until at step 430 the cell becomes packed with the insulation material. As noted above, because the system allows the user to define the particular airflow velocity, the system advantageously ensures a user can compact the material within the wall at any number of different amounts that are greater than gravity. Such a feature also ensures that if the wall needs to be subsequently accessed (e.g., plumbing or electrical issue/install), the compacted material will not pour out of the new opening.

The above noted steps can continue until each cell of the wall has been filled. At this time, the method can proceed to step 435, wherein the apertures within the wall are patched. At this time, the wall can be certified to meet the requirements for a true 4-hour firewall, as per local ordinances.

Accordingly, the above described machine and method provide a novel means for installing fireproof insulation into a building wall. As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A loose-fill granular insulation blowing machine, comprising:
a main body having a hopper chamber along a top end;
a funnel that is positioned beneath the hopper chamber;
a dispenser chamber having an outlet that is located along one side wall, said dispenser chamber being positioned beneath the funnel;
an agitator that is positioned within the dispenser chamber; and
a blower having an inlet that is positioned opposite to the one side wall of the dispenser chamber.

2. The system of claim 1, further comprising:
at least one air diffuser having a discharge end that is positioned within the dispenser chamber.

3. The system of claim 2, further comprising:
an air inlet coupler that is secured along the main body, said air inlet coupler being configured to engage an externally located air compressor.

4. The system of claim 1, wherein the agitator includes a central hub having a plurality of paddles arranged radially.

5. The system of claim 4, further comprising:
an electric motor that is in communication with the central hub and functioning to rotate the paddles.

6. The system of claim 5, further comprising a control panel having a plurality of actuators, said control panel being in communication with each of the electric motor and the blower unit and functioning to selectively activate the electric motor and blower unit.

7. The system of claim 1, further comprising:
a hose that is removably secured to the outlet.

8. The system of claim 1, further comprising:
a grate having a plurality of openings that is disposed between the hopper chamber and the funnel.

9. The system of claim 8, wherein the grate is constructed from metal.

10. A method of installing loose-fill granular insulation, said method comprising:
providing a loose-fill granular insulation blowing machine;
cutting at least one aperture along a top end of a building wall;
accessing a hollow cell within the building wall via the aperture;
activating the blowing machine and setting an airflow velocity;
pouring loose-fill granular insulation into a hopper of the machine;
dispensing, via a hose the loose-fill granular insulation into the aperture; and
patching the aperture.
